(19) United States
(12) Patent Application Publication
(10) Pub. No.: US 2023/0124996 A1
(43) Pub. Date: Apr. 20, 2023

(54) METHOD, SYSTEM AND VEHICLE FOR A CARBON NEUTRAL OR CARBON NEGATIVE VEHICLE PLATFORM

(71) Applicant: Renewable Energy Group, Inc., Ames, IA (US)

(72) Inventors: David Slade, Ames, IA (US); Martin Haverly, Ames, IA (US); Eric Bowen, Larkspur, CA (US)

(21) Appl. No.: 17/966,565

(22) Filed: Oct. 14, 2022

Related U.S. Application Data
(60) Provisional application No. 63/256,229, filed on Oct. 15, 2021.

(51) Int. Cl. G06Q 50/26; B01D 53/04; B01D 53/30; F02B 47/00

(52) U.S. Cl. CPC G06Q 50/26; B01D 53/04; B01D 53/30; F02B 47/00; B01D 2257/504; B01D 2257/404

(57) ABSTRACT

The present invention relates to a system and method for creating lower-carbon, carbon neutral, or carbon negative results through use of one or more combustion-powered devices. The invention further contemplates the ability to generate data or reports to demonstrate the results of the method and system.

### CROSS REFERENCE TO RELATED PATENT APPLICATION

This application is based upon U.S. Provisional Application Ser. No. 63/256,229 filed Oct. 15, 2021, the complete disclosure of which is hereby expressly incorporated by this reference.

### FIELD OF THE INVENTION

The present invention relates to a system, method and vehicle for a zero emission combustion-powered platform. More specifically, the present invention includes lower-carbon, carbon neutral, and/or carbon capture systems for combustion-powered devices which may occur through a combination of low carbon or carbon neutral fuels as well as an apparatus for capturing carbon emissions and other pollutants as part of a vehicle operating system. In addition, the present invention contemplates a system whereby the cumulative effect of a plurality of different combustion-powered devices may simultaneously produce useful work and a lower-carbon, carbon neutral, or carbon negative result as well as a method for evaluating the overall impact from such systems.

### BACKGROUND OF THE INVENTION

There has been significant focus on climate change and that, if action is not taken to reduce the amount of carbon in the atmosphere generated through emissions from various sources, irreversible damage to the environment will occur. One area of focus has is directed to vehicular devices and there has been significant focus on developing a wide range of electric vehicle devices (“EVs”). While EVs may present one possible solution to the issue of carbon emissions, EVs are still several years away from wide-spread adoption as the supporting infrastructure currently is not available. In addition, the charging infrastructure available today may still in a large part be supported by electricity generated by plants consuming fossil carbon sources such as coal and natural gas, and, as such, mitigate the potential value of such EVs. Other transportation segments such as heavy-duty trucks, industrial machinery, marine vessels, and aircraft may not be easily adapted to a battery-based system due to technical challenges inherent to these applications, the weight of having to carry a number of batteries and insufficient infrastructure, as mentioned previously. As such, there is a need to address carbon-neutral or carbon-negative combustion-powered solutions where EVs are unlikely or unable to serve as a viable solution.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

In one embodiment, a method for calculating the benefits of a lower-carbon, carbon neutral, or carbon negative system is disclosed.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic of a system to achieve a zero emission result;

FIG. 2 provides a block diagram of a method for calculating a score on the system to achieve a zero emission;

FIG. 3 represents a schematic of a combustion-powered device creating one of a carbon neutral, carbon negative or lower-carbon environment;

FIG. 4 shows a block diagram for treating ambient air to create one of a carbon neutral, carbon negative or lower-carbon environment;

FIG. 5 shows a schematic of a system to achieve a lower-carbon, carbon-neutral, carbon-negative, reduced-emission, zero-emission, or negative-emissions result; and

FIG. 6 shows a block diagram for a combustion-powered device to convert a fuel and polluted air to useful work and a tailpipe exhaust with lower carbon dioxide and/or pollutant concentration than that of incoming polluted air.

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

As used herein, the term “combustion-powered devices” may cover any device or vehicle wherein a fuel is combusted (i.e., burned) to directly or indirectly provide useful work. Examples of combustion-powered devices wherein a fuel is combusted to directly provide useful work are heavy-duty trucks, passenger vehicles, industrial machinery, agricultural equipment, marine vessels, and other vehicles wherein an internal combustion engine is used to convert a fuel to mechanical power to conduct useful work. Examples of combustion-powered devices wherein a fuel is combusted to indirectly provide useful work are gen-sets, locomotives, and some marine vessels wherein an internal combustion engine is used to convert a fuel to electrical or hydraulic power, which is then transferred to mechanical power to conduct useful work.

As used herein, the term “biomass” refers to any carbonaceous substance of recent biological origin, such that the carbon in the substance was recently in the atmosphere in the atmosphere carbon dioxide. “Recently,” as used herein, is defined in geological or atmospheric terms, such that it refers to a timeframe consisting of less than 1000 years from the present.

As used herein, the term “carbon capture device” refers to any device, system or combination of devices or systems used to capture carbon dioxide emissions from the exhaust resulting from the combustion of a fuel in an internal combustion engine.

As used herein, the term “total capture device” refers to any device or combination of devices used to capture any combination of one or more of the carbon dioxide (CO2), nitrogen oxide (NOx), sulfur oxide (SOx), particulate matter, hydrocarbon, heavy metals, or carbon monoxide emissions from the exhaust resulting from the combustion of a fuel in an internal combustion engine.

As used herein, the term “carbon sink” refers to a repository for storing the carbon in carbon dioxide for more than about 20 years. In embodiments, this repository can also be used to store other pollutants such as nitrogen oxide (NOx), sulfur oxide (SOx), particulate matter, hydrocarbon, heavy metals, and/or carbon monoxide (CO).

As used herein, the term “lower-carbon” refers to a result wherein the total carbon emissions are lower than that of a fossil carbon-based equivalent, but does not result in zero or less than zero carbon emissions.

As used herein, the term “carbon-neutral” refers to a result wherein the carbon emissions are zero or approximately zero.

As used herein, the term “carbon-negative” refers to a result wherein the carbon emissions are less than zero. Similarly, carbon-negative refers to a result wherein more carbon is sequestered than is released into the atmosphere.

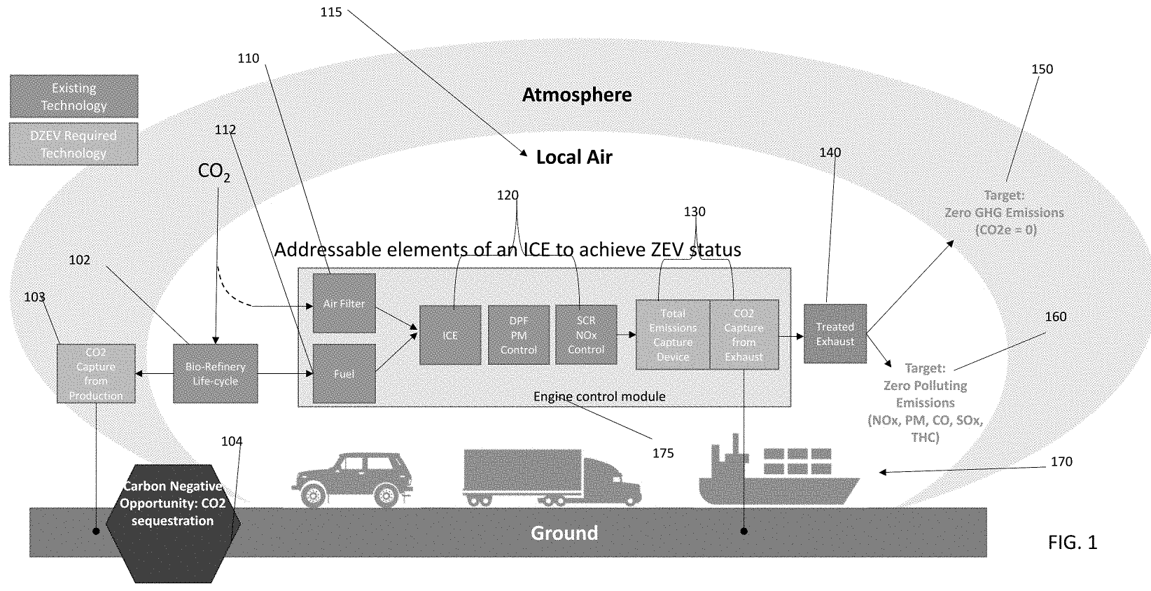

FIG. 1 provides a schematic drawing representing an overall system view of the present invention. The present method and system may use a combination of existing and new technologies or may rely on new technologies to achieve a lower-carbon, carbon negative, or carbon neutral result. Potentially part of the overall system is the use of a bio-refinery 102 which generates converts biomass to fuel 112 and, in the process, produces some amount of CO2. A portion of the CO2 may be captured by a system 103 and then sequestered as part of the same system or different system 104 such as through the use of a pipeline for storing CO2 in the ground.

Fuel 112 from the bio-refinery, such as biodiesel, renewable diesel, renewable naphtha, renewable propane, bio-methanol, bio-ethanol, bio-propanol, bio-ethanol, or other renewable or bio-based fuel known to those skilled in the art, are provided to a combustion-powered device 170 to an engine control module 175. The surrounding 115 is in this embodiment air which may be encountered in a metropolitan, industrialized, or rural areas and may contain any level of pollutants and particulates. The incoming fuel/air then passes through the internal combustion engine (ICE), particulate filter, and the NOx control 120 which will then generate an air level having a pollution calculation. The air continues to an emissions capture device which includes a CO2 capture device 130, which may be a mechanical, chemical or electrical system designed to remove various components from the air. As the exhaust is exiting the combustion-powered device it is measured by one or more sensors 140 which detect the various components contained in the air/exhaust and compares the levels with the first pollution level to provide a score.

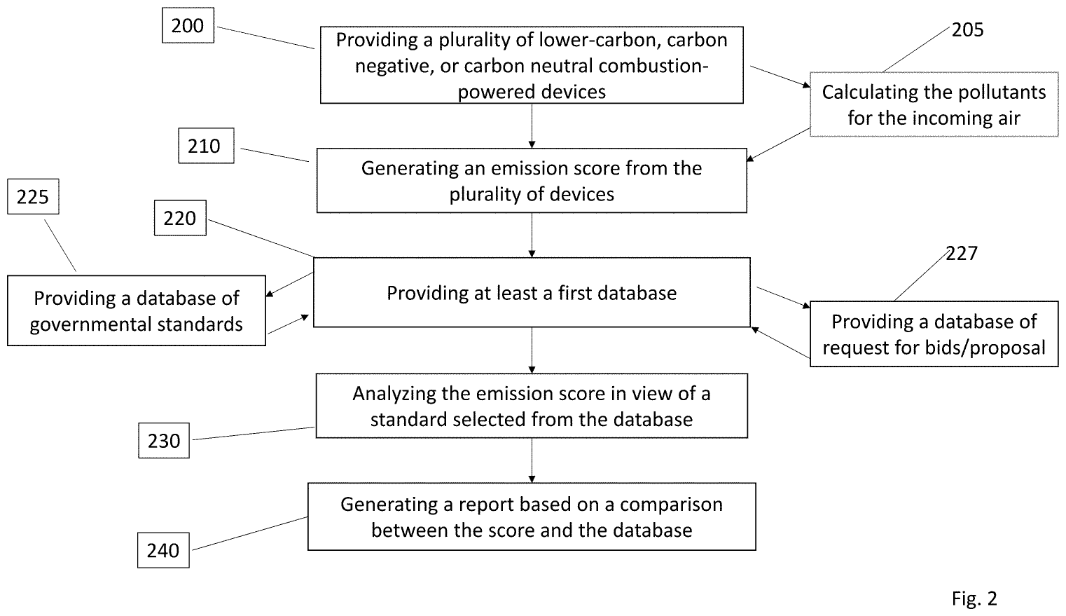

FIG. 2 shows a block diagram setting forth an exemplary method of creating a comparative score though uses of a lower-carbon, carbon negative, or carbon neutral system for combustion-powered devices. The method begins by providing a plurality of lower-carbon, carbon negative, or carbon neutral combustion-powered devices at step 200. There may be a step of calculating the pollution value of the surrounding and incoming air at step 205. A score relating to the collective use of the combustion-powered devices is created at step 210. A database is accessed at step 220 and the database may include different information concerning performance against other types of combustion-powered devices, other entities in the data collection area, historical data generated by the user from prior years and other useful information. In addition, other databases may be provided at step 225 which includes a database housing governmental standards and at step 227 which may include information of currently available proposal or opportunities for an operator to bid on. Any one or all of the databases may be utilized in connection with an assessment of the combustion-powered devices. Next, at step 230 the emission score is analyzed from the selected standard or other data from which a comparison is to be made. Finally, at step 240, a report is generated based on the comparison and analysis conducted in step 230. The report may be used for example in the operator submitting a bid for an outstanding governmental or customer request, or to show compliance with local emission standards or to obtain tax or other credits or incentives which may be offered by a governmental agency or sponsoring organization or to prove the operator is achieving lower carbon emissions.

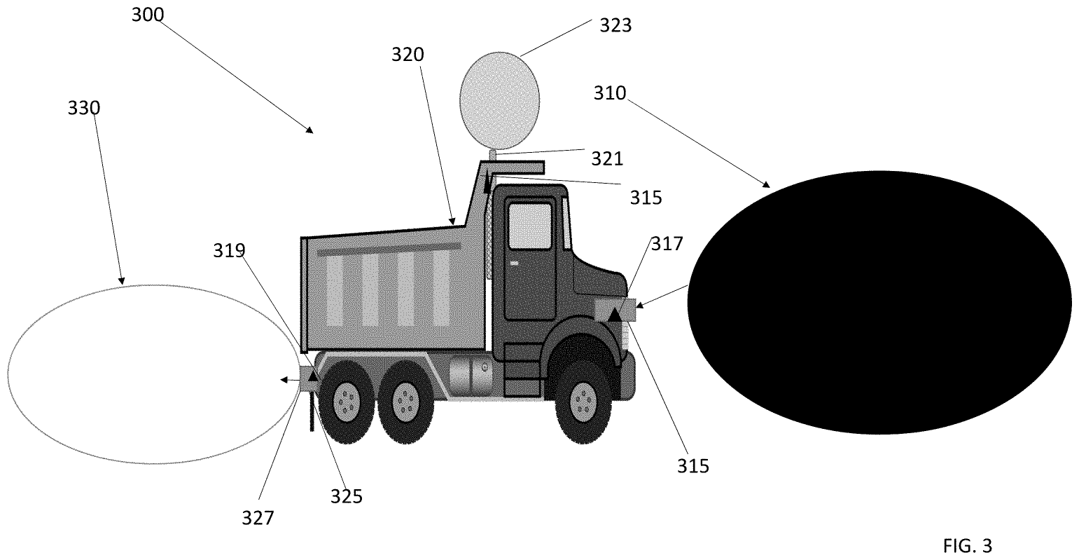

FIG. 3 provides a schematic 300 of a system for treating polluted, contaminated or other high carbon content air. Ambient air 310 containing one or more pollutants, contaminants or other elements is enters the combustion-powered device 320 via a treatment system 315 which will begin the process of removing designated contaminants. The incoming air 310 is measured by measuring device 317 to determine the level of pollutants or other contaminants in the air. Partially treated air 323 may be released at a first port 321 which has a first set of pollutants or contaminants removed. Treated air 330 may be released through second port 327 after passing through a second treatment system 325 and the treated air may have all the pollutants removed. Each of the treatment systems 315 and 325 may use mechanical, electrical or chemical treatment processes in order to treat the air traveling through the systems or alternatively, one system may use a different system than the other system, e.g., one may use a mechanical system and the other a chemical system. Each of the ports 321 and 327 may have a measuring device 315 and 319 to measure the amount of pollutants still in the air that is leaving the combustion-powered device 320. The operator of the vehicle may elect to release treated air through either of the first and second ports 321 and 325 due to such factors as fuel economy or targeting a specific contaminant.

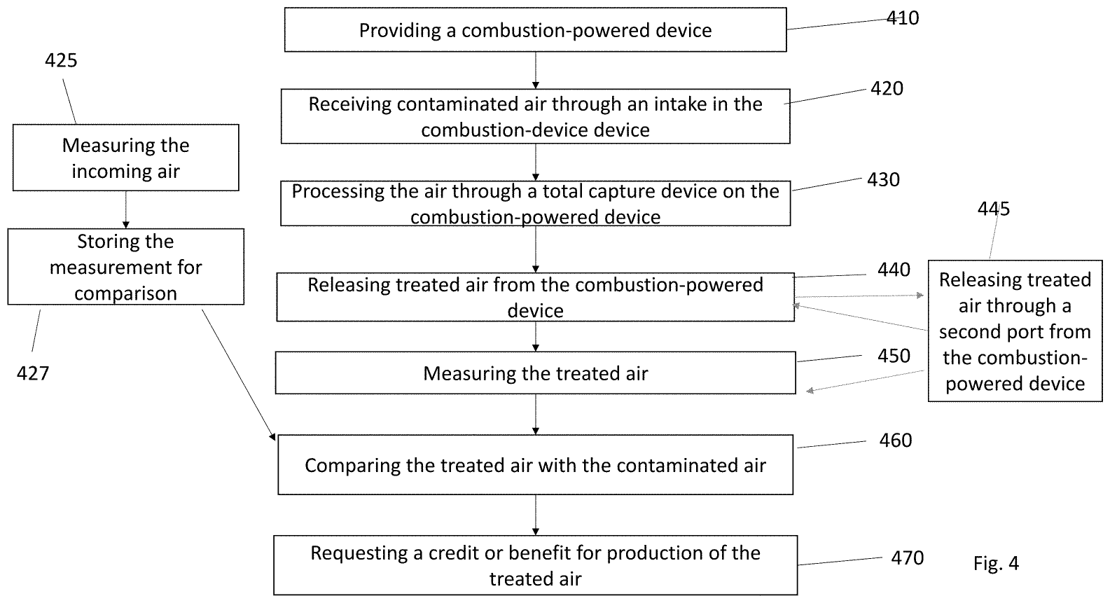

FIG. 4 provides a block diagram of a method for creating one of a carbon neutral, carbon negative, or lower-carbon environment and comprises the steps of initially providing a combustion-powered device at step 410. Next, ambient air which may contaminated with pollutants from a metropolitan or industrial area is received at an air intake point of the combustion-powered device at step 420. The incoming air may be measured at step 425 to determine the level of contaminants, pollutants and or carbon content or level. Once the measurement is obtained, the measurement is stored at step 427 for later comparison. The air is processed through a total capture device on the combust-powered device at step 430. Treated air is released from the combustion-powered device at step 440. Treated air may also be released by a second port at step 445. The treated air, being released from either the first or second port, is measured at step 450 to determine the level of carbon and or pollutants in the air. Next, the results of the measurements from the treated air is compared from the stored data of the incoming air at step 460. Based on the results of the treatment, the owner/operator of the combustion-powered device may request a credit or other benefit from a local, state or federal agency for improving the quality of air at step 470 of the metropolitan or industrial area where the air was collected.

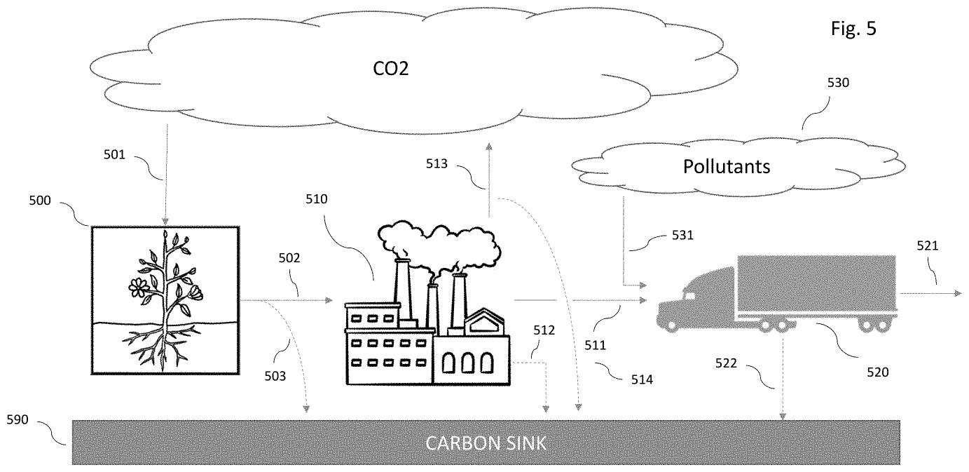

FIG. 5 provides a schematic drawing representing an overall system view of the present invention. The present method and system may use a combination of existing and new technologies or may rely on new technologies to achieve a lower-carbon, carbon negative, or carbon neutral result. Potentially part of the overall system is biomass (500) that has, over time, biologically fixed atmospheric carbon dioxide (501) into a solid or liquid form. Through agricultural or industrial practices, the biomass (500) is then harvested, in all or in part, such that a biomass feedstock (502) is brought to a bio-refinery (510) for further processing. In some embodiments, a portion of the biomass (503) can be handled in such a way as to sequester the carbon in a carbon sink (590).

The portion of the biomass (502) that is brought to the biorefinery (510) is subjected to processing such that one or more fuel products (511) are produced. In embodiments, the fuel (511) is a carbon-containing renewable fuel such as biodiesel, renewable diesel, renewable naphtha, renewable propane, bio-methanol, bio-ethanol, bio-propanol, bio-ethanol, or other renewable or bio-based fuel known to those skilled in the art. In embodiments, the bio-refinery (510) also produces one or more byproducts (512) that contain a portion of the carbon initially contained in the biomass feedstock (502). In some embodiments, these byproducts (512) may optionally be handled in such a way as to sequester the carbon in a carbon sink (590).

Additionally, in the fuel production process the bio-refinery (510), may also emit carbon dioxide emissions (513). In embodiments, a portion or all of carbon dioxide emissions (513) may be captured and sequestered (514) using a carbon dioxide capture device known to those skilled in the art.

The fuel (511) is subsequently transferred to a combustion-powered vehicle or device (520) for the purposes of conducting useful work, such as transportation. Also directed to vehicle (520) is polluted air (531) containing primarily oxygen (O2), nitrogen (N2), water vapor, argon, carbon dioxide (501), and pollutants (530). Pollutants (530) typically contains some measureable amount of nitrogen oxide (NOx), sulfur oxide (SOx), particulate matter, hydrocarbon, heavy metals, and/or carbon monoxide. The exact composition of pollutants (530) will be known to those skilled in the art to vary based on a variety of factors such as season, geography, and time of day. The polluted air (531) being directed into the intake of vehicle (520) in order to feed combustion

In the process of conducting useful work, combustion-powered vehicle (520) combusts the fuel (511) and produces emissions, of which a portion can be captured and sequestered as sequestered emissions (522) prior emitting the remainder as tailpipe emissions (521) into the atmosphere. In embodiments, the composition of certain impurities are lower in the tailpipe emissions (521) than in the polluted air (531) entering the air intake of the vehicle. In preferred embodiments, the composition of the sequestered emissions (522) is primarily carbon dioxide.

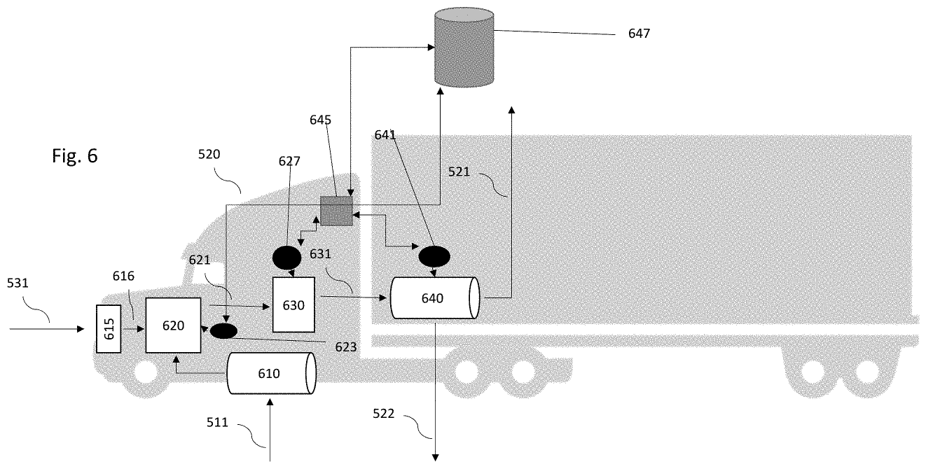

FIG. 6 provides a schematic or drawing representing a further embodiment of the present invent by providing additional detail to the combustion-powered vehicle (520). Potentially part of the vehicle (520) is air filter (615) which purifies the polluted air (531) entering the air intake of vehicle (520) to produce a cleaned air (616). Air filter (615) may be composed of at least one of a porous absorbent material (such as cellulose, glass fiber, or similar material known to those skilled in the art) or porous adsorbent material (such as activated carbon, or similar material known to those skilled in the art) to purify the polluted air (531) such that the composition of cleaned air (616) is lower in pollutants such as nitrogen oxide (NOx), sulfur oxide (SOx), particulate matter, hydrocarbon, heavy metals, and/or carbon monoxide than polluted air (531). Cleaned air (616) is then introduced into the combustion engine (620). Meanwhile, the fuel (511) is introduced into a fuel storage tank (610) to be stored and subsequently introduced into combustion engine (620). In embodiments, the fuel storage tank (610) is comprised of a vessel for holding at least one of fuel (511) and other fuels, a method of conveying and dispensing the fuel (511) into the combustion engine (620), and a method for returning any unused fuel (511) back to fuel storage tank (610). In further embodiments, fuel tank (610) also includes a method for maintaining the temperature of the fuel (511) at a controlled temperature. The cleaned air (616) and fuel (511) that is introduced into combustion engine (620) then undergoes combustion to produce heat, pressure, and combustion products (621).

In embodiments, combustion engine (620) is a reciprocating piston engine (such as a spark-ignition engine or compression-ignition engine), a rotary engine (such as a Wankel engine), a continuous combustion engine (such as a gas turbine engine), or similar device known to those skilled in the art. Combustion engine (620) converts the pressure generated through combustion of the cleaned air (616) and fuel (511) to mechanical energy, which is then used to produce useful work. In embodiments, combustion engine (620) includes systems for enhancing the combustion performance such that the combustion approaches ideal conditions such that the combustion products (521) is comprised entirely of carbon dioxide and water. These systems for enhancing the combustion performance may include exhaust gas recirculation, high pressure injection of fuel (511), advanced valve timing control, advanced injection control, advanced spark ignition control, advanced fuel/air mixing, or other means of enhancing combustion performance known to those skilled in the art.

In preferred embodiments, the combustion in combustion engine (620) is non-ideal such that the combustion products (521) is comprised of carbon dioxide and water and pollutants such as nitrogen oxide (NOx), sulfur oxide (SOx), particulate matter, hydrocarbon, heavy metals, and/or carbon monoxide. In these embodiments, combustion products (621) is introduced to aftertreatment system (630) where the concentration of pollutants is reduced such that the concentration of pollutants in treated exhaust (631) is lower than the concentration of pollutants in combustion products (621). In additional embodiments, aftertreatment system (630) is comprised of a plurality of devices known to those skilled in the art to chemical modify or remove pollutants such as nitrogen oxide (NOx), sulfur oxide (SOx), particulate matter, hydrocarbon, heavy metals, and/or carbon monoxide. These devices may include at least one of a direct oxidation catalyst, selective catalytic reducer, catalytic reducer, particulate matter filter, particulate matter trap, or other device known to those skilled in the art.

In still other embodiments, the concentration of particulate matter in treated exhaust (631) is at least 90%, at least 95%, at least 96%, at least 97%, at least 98%, at least 99%, at least 99.5%, or at least 99.9% lower than in combustion products (621). In embodiments, the concentration of nitrogen oxide (NOx) in treated exhaust (631) is at least 90%, at least 95%, at least 96%, at least 97%, at least 98%, at least 99%, at least 99.5%, or at least 99.9% lower than in combustion products (621). In yet further embodiments, the sum of nitrogen oxide, sulfur oxide, particulate matter, hydrocarbon, heavy metals, and carbon monoxide is at least 90%, at least 95%, at least 96%, at least 97%, at least 98%, at least 99%, at least 99.5%, or at least 99.9% lower than in combustion products (621).

The treated exhaust (631) is then introduced to total capture device (640) where a portion of the water vapor, carbon dioxide, and remaining pollutants are removed from the treated exhaust (631) to produce tailpipe exhaust (521). Total capture device (640) is comprised of one or a plurality of devices such as condensers, gas adsorbers (containing adsorbent media such as activated carbon, zeolites, polymers, metal-organic frameworks, and/or metal oxides), barrier filters, gas scrubbers, membrane separators, catalytic converters, or other means of gas purification known to those skilled in the art. As known to those skilled in the art, depending upon the selection of devices including total capture device (640), additional equipment or systems are necessary for the proper function of the device.

In some embodiments, total capture device (640) includes one or more gas adsorbers, configured in series and/or in parallel, wherein the adsorbent media is suitable to capture at least 20%, at least 30%, at least 40%, at least 50%, at least 60%, at least 70%, at least 80%, or at least 90% of the carbon dioxide in the treated exhaust (631). In preferred embodiments, the adsorbent media in total capture device (640) is also suitable to capture at least 20%, at least 30%, at least 40%, at least 50%, at least 60%, at least 70%, at least 80%, or at least 90% of the nitrogen oxide in the treated exhaust (631).

In other embodiments, the total capture device (640) produces sequestered emissions (622) that includes carbon dioxide. In preferred embodiments, the sequestered emissions (622) includes carbon dioxide and pollutants such as nitrogen oxides.

It will thus be seen according to the present invention a highly advantageous system and method for providing a lower-carbon, carbon neutral, or carbon negative combustion-powered device has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A method for creating one of a carbon neutral, carbon negative or lower-carbon environment and comprises the steps of;
providing a combustion-powered device;
receiving ambient air which may contaminated with pollutants from a metropolitan or industrial area at an air intake point of the combustion-powered device;
measuring the air to determine the level of contaminants, pollutants and or carbon content or level;
storing the measurement;
processing the air through a carbon or pollution capture system on the combustion-powered device;
releasing treated air from at least one port on the combustion-powered device;
measuring the treated air to determine the level of carbon and or pollutants in the air;
comparing the results of the measurements from the treated air with the stored data from the incoming air; and
requesting a credit or other benefit from a local, state or federal agency for improving quality of air.

2. A plurality of devices for achieving a lower-carbon, carbon neutral, or carbon negative environment, comprising;
at least one combustion-powered device, the combustion-powered device receives ambient air containing one or more pollutants, contaminants or other elements;
a treatment system disposed on the at least one combustion-powered device and designed for removing designated contaminants, the treatment system using one of mechanical, chemical or electrical treatment systems;
a measuring device for determining the level of pollutants or other contaminants in the air;
at least one air exhaust port for releasing air into the environment; and
wherein the measuring device compares the level of pollutants leaving the at least one combustion-powered vehicle to the air received in the treatment system.

3. The plurality of devices as recited in claim 2, wherein each of the combustion-powered devices has a second air exhaust port and air released from the second air exhaust port has different properties than air release from the at least one exhaust port.

4. A method of creating a comparative score though uses of a lower-carbon, carbon negative, or carbon neutral system for combustion-powered devices, comprising the steps of;
providing a plurality of lower-carbon, carbon negative or carbon neutral combustion-powered devices;
calculating the pollution value of the surrounding and incoming air;
generating a score relating to the collective use of the combustion-powered devices;
accessing at least one database;
analyzing information from the at least one database;
generating a report based on the step of analyzing.

5. The method as recited in claim 3, wherein the at least one database includes one of governmental standards, proposals, bids or historical performance.
